(19) United States
(12) Patent Application Publication
(10) Pub. No.: US 2023/0279905 A1
(43) Pub. Date: Sep. 7, 2023

(54) Coupler for Sterndrive Watercraft

(71) Applicant: Michael Clesceri, Anderson, SC (US)

(72) Inventor: Michael Clesceri, Anderson, SC (US)

(21) Appl. No.: 18/116,039

(22) Filed: Mar. 1, 2023

Related U.S. Application Data
(60) Provisional application No. 63/317,240, filed on Mar. 7, 2022.

(51) Int. Cl. F16D 3/12; B63H 23/34; F16D 3/06

(52) U.S. Cl. CPC F16D 3/12; B63H 23/34; F16D 3/06; B63H 2023/342; F16D 2300/20; F16D 2300/22

(57) ABSTRACT

A marine engine coupler for connecting a sterndrive input shaft to an engine flywheel. A splined central shaft connects the sterndrive input shaft to the coupling. Polyurethane dampers interface between the engine to the sterndrive to reduce vibration. There is a visual indicator on the coupler to allow the user to assess the integrity of the dampening material and give the user an indication that the dampening materials needs to be replaced.

### CROSS-REFERENCE TO RELATED APPLICATIONS

This application is based on and claims priority of provisional patent application 63/317,240 filed Mar. 7, 2022.

### BACKGROUND AND SUMMARY OF THE INVENTION

This invention relates to power drive systems and more particularly to a coupling for sterndrive watercraft.

The current sterndrive coupler is welded together and not repairable. During normal use, the splines wear out and force the user to discard the entire coupler and purchase a costly replacement. In addition, the current couplers on the market are prone to catastrophic failure of the dampening material (commonly rubber) that prevents that sterndrive from generating any propulsion that can leave the boater stranded. Another issue is that the current sterndrive couplers on the market are rated for only 600 ft-lbs of torque and applicant's inventive device is capable of at least 1,200 ft-lbs.

Although there are several sterndrive manufacturers and builders that are selling sterndrives rated for more than 1,000 ft-lbs of torque, users of these drives are experiencing premature failure of the rubber dampening material in these couplers with total loss of propulsion and potentially expensive towing charges.

The inventive coupler is field serviceable and 100% rebuildable, which presents an advantageous alternative to the OEM coupler. The invention provides a splined central shaft that can be replaced for approximately half the cost of the current couplers on the market. As opposed to using the failure-prone rubber dampening materials, the invention uses polyurethane dampening material which is widely used in industrial and automotive dampening applications and can be field replaced. Furthermore the inventive coupler has an external indicator to allow the user to assess the integrity of the dampening material and give the user an indication that the dampening materials needs to be replaced.

### DESCRIPTION OF THE DRAWINGS

FIG. 1 is a top perspective view of the inventive coupler.

FIG. 2 is an exploded perspective view of the inventive coupler.

### DESCRIPTION OF THE PREFERRED EMBODIMENT

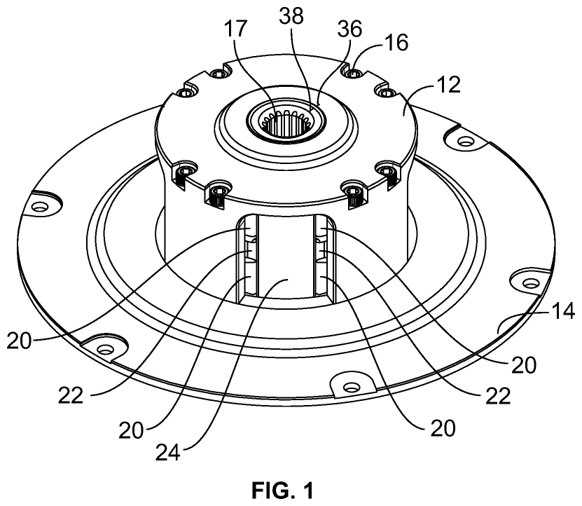

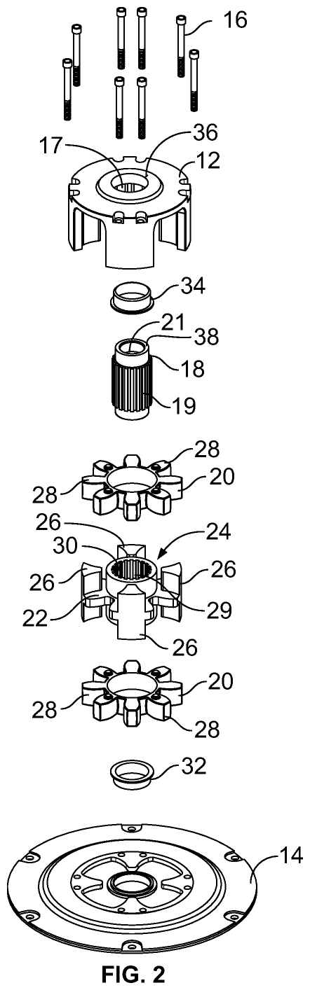

Turning to FIG. 1, we see a perspective assembled view of an inventive coupler 10. FIG. 2 is an exploded view of the coupler 10. The coupler 10 is comprised of a billet aluminum housing 12 having downwardly oriented jaws 13. The housing 12 is attached to a backing plate 14 by means of fastening screws 16. The backing plate 14 is mounted to the engine's flywheel in a conventional manner. There is a central opening 17 centrally disposed in the housing 12.

As seen in FIG. 2 there is a splined chromoly center shaft 18 that is heat treated and black oxide coated. It has external splines 19 and internal splines 21. The center shaft 18 has a fixed axial center line that is in alignment with the central opening 17 on the billet aluminum housing 12 when the coupler 10 is assembled. When the billet housing 12 and backing plate are fastened together, the center shaft 18 and housing 12 turn as one unit. There are two polyurethane dampeners 20 that are fitted to the top and bottom of a center plate or portion 22 of a dampener hub 24. The dampener hub 24 has a series of equally spaced upstanding legs 26, which in this case there are four illustrated legs 26. The center plate or portion 22 separates the top and bottom of the dampener hub 24. One of the polyurethane dampers 20 is placed on the top of the center plate 22 and the other is placed below the center plate 22, with the center plate 22 sandwiched between the two polyurethane dampers 20 when assembled. The two polyurethane dampers 20 have outstanding fingers 28 that extend radially out from the center of the polyurethane dampers 20. The fingers 28 extend slightly beyond the perimeter of the upstanding legs 26 so that they are positioned between the housing 12 and the dampener hub 24 so that they are the sole interface that transfers the torque from the engine to the sterndrive. The torque load from the engine slightly deforms the polyurethane dampers 20 and provides the dampening effect for the coupler.

The center shaft 18 is pressed into the dampener hub 24 so that the external splines 19 on the center shaft 18 are engaged by complementary grooves 29 on the inside of a central passageway 30 in the dampener hub 24. The center shaft 18 and dampener hub 24 assembly rides on two shaft bushings 32, 34 that are pressed into the backing plate 14 and billet aluminum housing 12 respectively. When the backing plate 14 is mounted to the engine's flywheel by means of screw fasteners (not illustrated) the input shaft for the sterndrive, which has external splines (not illustrated) slides into the center shaft 18 and engages the internal splines 21. As the engine rotates the backing plate 14 and housing 12 move as one unit. The dampener hub 24 and the internally mounted components ride inside the billet aluminum top housing 12 with the polyurethane dampeners 20 as the interface between the two assemblies, which is the source of the vibration dampening.

There is a notch 36 formed in the top of the billet aluminum housing 12. There is a complementary notch 38 in the top of the dampener hub 24. When the dampener hub 24 is first mounted into the billet aluminum top housing 12, the notches 36, 38 are aligned next to each other as seen in FIG. 1. As the polyurethane dampeners 20 wear down the dampener hub 24 and center shaft 18 will rotate within the billet aluminum top housing 12 and cause the two notches 36, 38 to become misaligned, which gives a visual indication that a replacement of the polyurethane dampeners 20 is required. If the splines on the splined center shaft 18 become worn, which occurs during operation, the user has a visual indication of the worn splines and the center shaft 18 needs replacement. Thus, the polyurethane dampeners 20 or the splined center shaft 18 can be replaced without destroying and requiring an entire replacement of the coupler 10. The notches 36, 38 can take many forms such as indentations, paint lines, raised strips, etc. The housing 12, dampener hub 24 and back plate 14 are preferably all machined from billet aluminum and are anodized to prevent corrosion.

The inventive coupler 10 also provides that should the polyurethane dampeners 20 completely wear down the dampener hub 24 is designed so that the jaws 13 on the billet aluminum top housing 12 will engage the upstanding legs 26 on the dampener hub 24 and still deliver substantially 100% of the engine's power to the input shaft of the sterndrive and to the propeller.

Thus there has been provided a coupler for sterndrive watercraft that allows for the replacement of the dampeners and center shaft without the necessity of replacing the entire coupler. While the invention has been described in conjunction with a specific embodiment, it is evident that many alternatives, modifications and variations will be apparent to those skilled in the art in light of the foregoing description. Accordingly, it is intended to embrace all such alternatives, modifications and variations as fall within the spirit and scope of the appended claims.

What is claimed is:

1. A marine engine coupler for connecting a sterndrive input shaft to an engine flywheel comprising:
a backing plate for mounting to the engine flywheel;
a center shaft with an inner end and an outer end, the inner end adapted for mounting to the backing plate;
the center shaft having inner and outer splines, the inner splines receiving the sterndrive input shaft;
a dampener hub with a splined central passageway for receiving in driving engagement the center shaft outer splines;
a plurality of legs extending out from the splined central passageway of the dampener hub;
a damper housing having a top surface and a plurality of jaws extending axially downward away from the top surface;
the outer end of the center shaft connected to the damper housing;
fasteners for mounting the damper housing to the backing plate with the center shaft and dampener hub secured between the damper housing and the backing plate with the jaws extending axially downward away from the top surface and disposed between the plurality of legs on the dampener hub; and
resilient dampers mounted between the dampener hub and the damper housing for transmitting the force from the engine flywheel to the sterndrive input shaft.

2. The marine engine coupler for connecting a sterndrive input shaft to an engine flywheel of claim 1 and further comprising an inner bushing mounted to the backing plate and receiving the inner end of the of the center shaft for connecting the inner end to the backing plate.

3. The marine engine coupler for connecting a sterndrive input shaft to an engine flywheel of claim 2 and further comprising an outer bushing mounted to the damper housing and receiving the outer end of the of the center shaft for connecting the outer end to the damper housing.

4. The marine engine coupler for connecting a sterndrive input shaft to an engine flywheel of claim 1 wherein the dampener hub has a center plate with a top and bottom surrounding the central passageway with a resilient damper mounted on the top and a second resilient damper mounted on the bottom.

5. The marine engine coupler for connecting a sterndrive input shaft to an engine flywheel of claim 1 and further comprising a first alignment marking on the top surface of the damper housing, a second alignment marking on the center shaft, the first and second alignment markings aligned with each other when the damper housing is securely attached to the backing plate and the resilient dampers and the center shaft are capable of transmitting substantially all of the engine force to the sterndrive, and the first and second alignment markings are out of alignment indicating that the resilient dampers are worn and require replacement.

6. A marine engine coupler for connecting a sterndrive input shaft to an engine flywheel comprising:
a backing plate for mounting to the engine flywheel;
a center shaft with an inner end and an outer end, the inner end adapted for mounting to the backing plate;
the center shaft having inner and outer splines, the inner splines receiving the sterndrive input shaft;
a dampener hub with a splined central passageway for receiving in driving engagement the center shaft outer splines;
a damper housing having a top surface and the outer end of the center shaft connected to the damper housing;
fasteners for mounting the damper housing to the backing plate with the center shaft and dampener hub secured between the damper housing and the backing plate;
resilient dampers mounted between the dampener hub and the damper housing for transmitting the force from the engine flywheel to the sterndrive input shaft;
a first alignment marking on the top surface of the damper housing, a second alignment marking on the center shaft, the first and second alignment markings aligned with each other when the damper housing is securely attached to the backing plate and the resilient dampers and the center shaft are transmitting substantially all of the engine force to the sterndrive, and the first and second alignment markings are out of alignment indicating that the resilient dampers are worn and require replacement.

7. The marine engine coupler for connecting a sterndrive input shaft to an engine flywheel of claim 1 and further comprising:
a plurality of legs extending out from the splined central passageway of the dampener hub;
a plurality of jaws extending axially downward away from the top surface;
the jaws extending axially downward away from the top surface and disposed between the plurality of legs on the dampener hub.

8. The marine engine coupler for connecting a sterndrive input shaft to an engine flywheel of claim 6 and further comprising an inner bushing mounted to the backing plate and receiving the inner end of the of the center shaft for connecting the inner end to the backing plate.

9. The marine engine coupler for connecting a sterndrive input shaft to an engine flywheel of claim 8 and further comprising an outer bushing mounted to the damper housing and receiving the outer end of the of the center shaft for connecting the outer end to the damper housing.

10. The marine engine coupler for connecting a sterndrive input shaft to an engine flywheel of claim 6 wherein the dampener hub has a center plate with a top and bottom surrounding the central passageway with a resilient damper mounted on the top and a second resilient damper mounted on the bottom.

11. A method of indicating wear of components in a marine engine coupler for connecting a sterndrive input shaft to an engine flywheel comprising:
attaching a backing plate to the engine flywheel;
attaching a distal end of a center shaft to the backing plate;
attaching the center shaft to the sterndrive input shaft;
attaching a dampener hub to the center shaft;
connecting a damper housing having a top surface to a proximal end of the center shaft;
mounting the damper housing to the backing plate with the center shaft and dampener hub secured between the damper housing and the backing plate;
mounting resilient dampers between the dampener hub and the damper housing for transmitting the force from the engine flywheel to the sterndrive input shaft;
placing a first alignment marking on the top surface of the damper housing,
placing a second alignment marking on the center shaft,
aligning the first and second alignment markings with each other when the damper housing is securely attached to the backing plate and the resilient dampers and the center shaft are transmitting substantially all of the engine force to the sterndrive, and the first and second alignment markings are out of alignment indicating that the resilient dampers are worn and require replacement.
